(19) United States
(12) Patent Application Publication
(10) Pub. No.: US 2026/0318708 A1
(43) Pub. Date: Oct. 15, 2026

(54) ELECTRICAL OSCILLATOR SELF-CALIBRATION USING MECHANICAL OSCILLATOR

(71) Applicant: STMicroelectronics International N.V., Geneva (CH)

(72) Inventor: Matteo Quartiroli, Certosa di Pavia (IT)

(21) Appl. No.: 19/175,922

(22) Filed: Apr. 10, 2025

(51) Int. Cl. G01C 25/00; G01C 19/5776; G01P 21/00

(52) U.S. Cl. CPC G01C 25/00; G01C 19/5776; G01P 21/00

(57) ABSTRACT

A method for calibration of a microelectromechanical system (MEMS) device includes generating a first periodic signal with a mechanical frequency, generating a second periodic signal with an electrical frequency, generating a ratio signal indicating a relationship between the mechanical frequency and the electrical frequency, and generating an electrical oscillator calibration signal based on the ratio signal and a predetermined mechanical oscillator calibration signal. The MEMS device may include a mechanical oscillator (e.g., including a gyroscope) and an electrical oscillator (e.g., including an accelerometer) configured to generate the first periodic signal and the second periodic signal, respectively, a counter circuit configured to generate the ratio signal, and an electrical correction calculator circuit configured to output the electrical oscillator calibration signal. The MEMS device may be included in a system that includes an application processor configured to use the corrected periodic signal as a system clock.

### TECHNICAL FIELD

The present invention relates generally to electronic devices, and, in particular embodiments, to structures of microelectromechanical devices including an electrical oscillator and a mechanical oscillator, and methods of operation thereof.

### BACKGROUND

Electronic devices, such as an integrated circuit (IC) employing digital components, rely on oscillating signals (i.e., periodic signals) for a variety of functions including generating a system clock that may be used as the basis for synchronizing behavior and communication. The periodic signals used as a basis for the system clock can be received from an external source or may be generated locally, such as using an embedded oscillator. Oscillators may be linear (harmonic producing a sinusoidal waveform) or nonlinear (producing a non-sinusoidal periodic waveform), one example of which is a relaxation oscillator.

One category of oscillator is an electronic oscillator which uses an electronic resonator to produce a periodic signal. A common type of electronic oscillator is a crystal oscillator, which uses a piezoelectric crystal as the electronic resonator. When an electronic oscillator is included as part of an electronic device, it is often referred to as a local oscillator (LO). Other types of electronic oscillators also exist, such as those leveraging basic circuit components, such as a resistor-capacitor (RC) oscillator circuit, an inductor-capacitor (LC) oscillator circuit, and more complicated combinations thereof.

Another category of oscillator is a mechanical oscillator which uses resonant mechanical motion (i.e., physical vibration or rotation) to produce a periodic signal. One example of a mechanical oscillator in the context of integrated circuits is a microelectromechanical (MEMS) gyroscope, such as a vibrating structure gyroscope (VSG). Mechanical oscillators and electrical oscillators can be included in the same electronic device, such as in a sensor device that can measure information about linear and rotational movement.

### SUMMARY

In accordance with an embodiment of the invention, a method for calibration of a microelectromechanical system (MEMS) device includes generating a first periodic signal with a mechanical frequency using a mechanical oscillator circuit of the MEMS device, generating a second periodic signal with an electrical frequency using an electrical oscillator circuit of the MEMS device, generating a ratio signal indicating a relationship between the mechanical frequency and the electrical frequency using a counter circuit of the MEMS device, and generating an electrical oscillator calibration signal based on the ratio signal and a predetermined mechanical oscillator calibration signal using an electrical correction calculator circuit of the MEMS device.

In accordance with another embodiment of the invention, a MEMS device includes a mechanical oscillator circuit configured to generate a first periodic signal with a mechanical frequency, an electrical oscillator circuit configured to generate a second periodic signal with an electrical frequency, a counter circuit coupled to the mechanical oscillator circuit and the electrical oscillator circuit, and an electrical correction calculator circuit coupled to the counter circuit. The counter circuit is configured to generate a ratio signal indicating a relationship between the mechanical frequency and the electrical frequency. The electrical correction calculator circuit is configured to output an electrical oscillator calibration signal generated using the ratio signal and a predetermined mechanical oscillator calibration signal.

In accordance with still another embodiment of the invention, a system includes a MEMS device that includes a mechanical oscillator circuit, an electrical oscillator circuit, a counter circuit coupled to the mechanical oscillator circuit and the electrical oscillator circuit, and an electrical correction calculator circuit coupled to the counter circuit. The MEMS device is configured to perform a method for calibration of the MEMS device including generating a first periodic signal with a mechanical frequency using the mechanical oscillator circuit, generating a second periodic signal with an electrical frequency using the electrical oscillator circuit, generating a ratio signal indicating a relationship between the mechanical frequency and the electrical frequency using the counter circuit, generating an electrical oscillator calibration signal based on the ratio signal and a predetermined mechanical oscillator calibration signal using the electrical correction calculator circuit, and correcting the second periodic signal using the electrical oscillator calibration signal to generate a corrected periodic signal. The system further includes an application processor configured to use the corrected periodic signal as a system clock.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an example microelectromechanical system (MEMS) device that includes a calibration circuit configured to generate an electrical oscillator calibration signal based on a mechanical oscillator calibration signal and a ratio signal indicating a relationship between a mechanical oscillator frequency and an electrical oscillator frequency in accordance with embodiments of the invention;

FIG. 2 illustrates an example method for calibration of a MEMS device in accordance with embodiments of the invention;

FIG. 3 illustrates an example MEMS device that is configured to be triggered to perform a self-calibration method by an application processor according to a user preference in accordance to embodiments of the invention;

FIG. 4 illustrates an example MEMS device that includes a timing circuit configured to periodically trigger performance of a self-calibration method in accordance with embodiments of the invention;

FIG. 5 illustrates an example MEMS device that includes an environmental circuit configured to trigger performance of a self-calibration method based on an environmental event detected using an environmental signal from an environmental sensor in accordance with embodiments of the invention;

FIG. 6 illustrates a specific example of an environmental circuit that is configured to receive a temperature signal from a temperature sensor and trigger performance of a self-calibration method based on a temperature event detected using the temperature signal in accordance with embodiments of the invention; and

FIG. 7 illustrates a specific example of a MEMS device where the electrical oscillator circuit is coupled to an optional divider circuit and the counter circuit receives an output signal of a phase-locked loop coupled to the mechanical oscillator circuit at a clock input in accordance with embodiments of the invention.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

Electronic devices and systems, such as integrated circuits, may include both an electrical oscillator (e.g., an electronic oscillator such as an LO) and a mechanical oscillator (e.g., a MEMS gyroscope). For example, a MEMS sensor may include both a mechanical oscillator such as a MEMS gyroscope (GY) and an accelerometer (XL) that can use an electrical oscillator to function, such as when the gyroscope is turned off. In some cases, the electronic device or system can use either the mechanical oscillator or the electrical oscillator as a time basis (i.e., a system clock). Specifically, the oscillation frequency of an internal oscillator (i.e., an embedded oscillator) may be used directly as the system clock or indirectly as a reference frequency from which the system clock is derived, such as using a phase-locked loop (PLL). For example, the output data rate (ODR) may be based on the system clock.

Both types of oscillator may be subject to device-to-device variation requiring tuning after fabrication. For example, devices embedding a mechanical oscillator may be tied up to the working frequency of the resonator and therefore follow a device-to-device natural frequency spread, which can be in the range±10%. One specific consequence of this natural frequency spread may be device-to-device ODR spread. Even if trimmed, all devices are affected by device-to-device ODR spread, moreover not all sensors can be trimmed during the test and trim phase. Inaccurate ODR may result in performance loss and/or communication failures between the device (e.g., a sensor) and external system components, such as an application processor. In the case of a sensor device, this may be particularly unacceptable as sensors may be used in critical applications.

Systematic frequency error of mechanical oscillators like a gyroscope may be reduced or eliminated using digital algorithms that define a mechanical calibration value GYₜᵣᵢₘ which may be referred to as a trim value. Similarly, an electrical calibration value may also be determined using digital algorithms to adjust the frequency spread of electrical oscillators. The electrical calibration value may be referred to herein as XLₜᵣᵢₘ to indicate that an accelerometer is often associated with the electrical trim value, but the same concept still applies to electrical oscillators in devices without an accelerometer.

Environmental factors, such as temperature, humidity, supply voltage, etc., may affect the oscillation frequency of embedded oscillators, but the environmental impact on electrical oscillators and mechanical oscillators may be different. Devices using an embedded mechanical oscillator like a gyroscope as the clock basis may be relatively environmentally stable (e.g., over environment variables like temperature and supply voltage, so once the mechanical oscillator is calibrated (i.e., trimmed), such as to digitally adjust the ODR, the accuracy may remain high for the lifetime of the device. In contrast, electrical oscillators such as those used to provide accelerometer functionality, may be relatively more sensitive to environmental factors like temperature and voltage resulting in multiple times the frequency spread compared to mechanical oscillators.

One option to address electrical oscillator instability is to always keep the mechanical oscillator enabled for use as a time reference. Yet, this solution is impractical and undesirable as mechanical oscillator may require several times more current than the electrical oscillator. Another option is to use an external signal as a reference in a digital algorithm to correct the ODR. This may advantageously allow real-time correction of the ODR as well as frequency and phase alignment (e.g., without powering the mechanical oscillator), but has the drawbacks of requiring an additional dedicated pin and additional signals are not available in many systems.

A third option is to manually re-trim the electrical oscillator and/or manually correct the ODR using an algorithm executed on an application processor. This strategy has the undesirable characteristic of not being automatic (i.e., requiring external intervention). Further, such a re-trim or algorithm would need to be repeated every time the device is powered off. Internal trim registers of the device may also need to be exposed (e.g., to the application processor), which may be undesirable for stability and security reasons. Another disadvantage may be that the application processor must be kept enabled to execute all calculations and the application processor performing these operations is generally more power consuming than integrated logic.

In accordance with embodiments herein described, the invention proposes a self-calibration (i.e., a self-correction) technique that utilizes the stability of an included mechanical oscillator to calculate a correction value for an electrical oscillator. Specifically, a calibration circuit included in the device with the mechanical oscillator and the electrical oscillator is configured to measure a relationship between the current frequency of the mechanical oscillator (a mechanical frequency fₘ) and the current frequency of the electrical oscillator (an electrical frequency fₑ) and use the relationship along with a mechanical calibration value (GYₜᵣᵢₘ) to determine an electrical calibration value (XLₜᵣᵢₘ) in real-time or substantially in real-time. The self-calibration may have an advantageously Since the mechanical oscillator itself only powered on to perform the self-calibration, the invention may have the advantage of being more power efficient than comparable solutions.

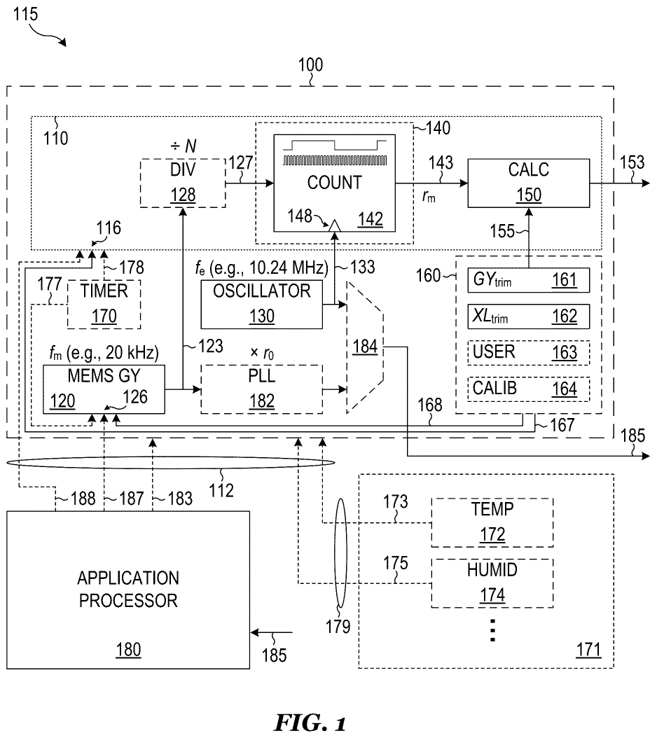

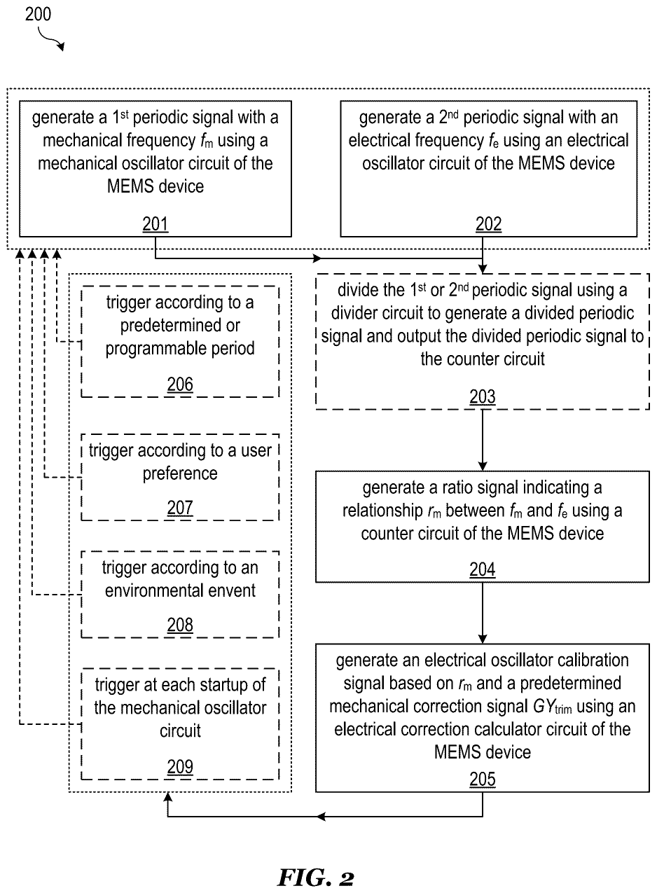

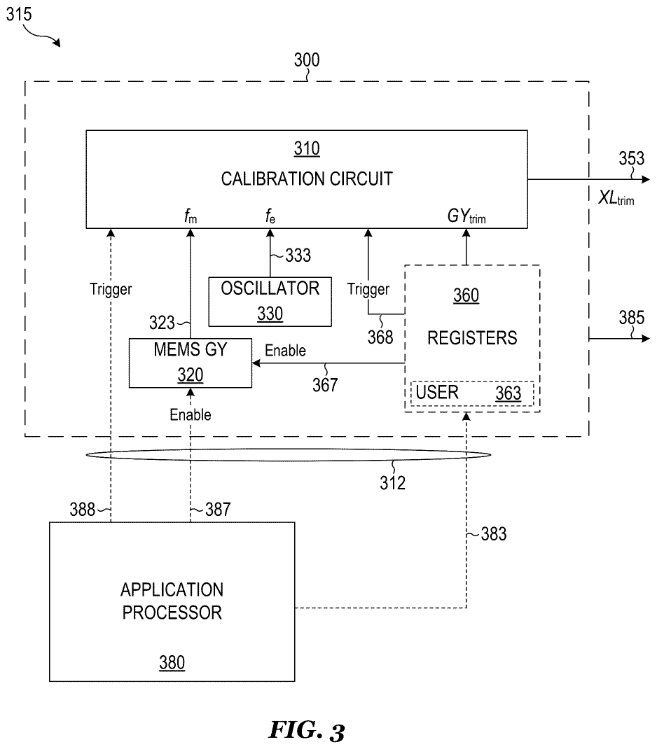

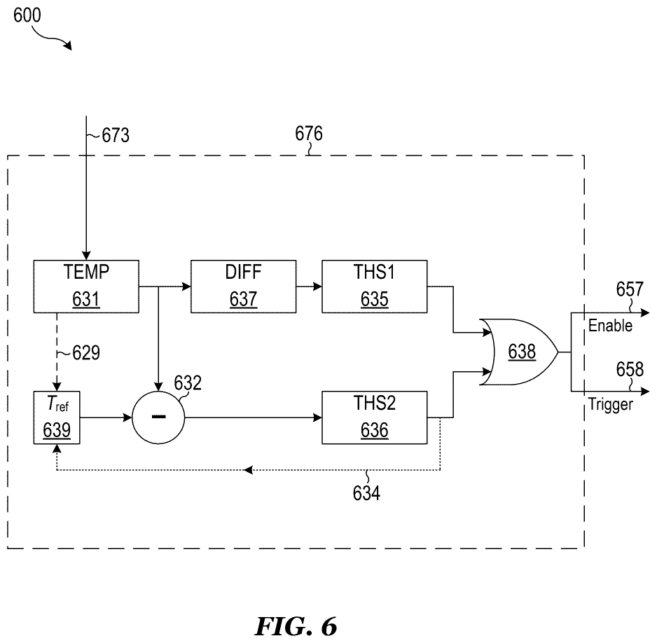

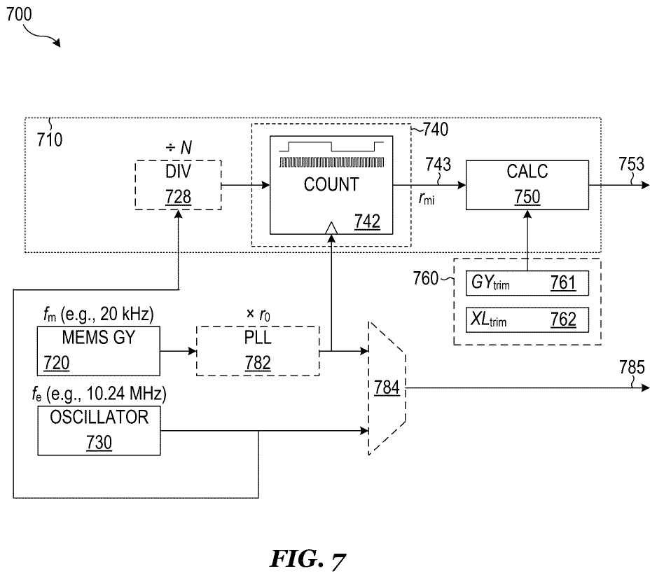

Embodiments provided below describe various structures, systems, and methods, of MEMS devices, and in particular embodiments, MEMS devices that include a calibration circuit configured to generate an electrical oscillator calibration signal based on a mechanical oscillator calibration signal and a ratio signal indicating a relationship between a mechanical oscillator frequency and an electrical oscillator frequency. The following description describes the embodiments. FIG. 1 is used to describe an example MEMS device. An example method for calibration of a MEMS device is described using FIG. 2. Three more example MEMS devices are described using FIGS. 3-5. An example environmental event circuit is described using FIG. 6 while another example MEMS device is described using FIG. 7.

FIG. 1 illustrates an example MEMS device that includes a calibration circuit configured to generate an electrical oscillator calibration signal based on a mechanical oscillator calibration signal and a ratio signal indicating a relationship between a mechanical oscillator frequency and an electrical oscillator frequency in accordance with embodiments of the invention.

Referring to FIG. 1, a MEMS device 100 includes a calibration circuit 110 that is operatively coupled to both a mechanical oscillator circuit 120 and an electrical oscillator circuit 130. The mechanical oscillator circuit 120 may be any suitable type of oscillator based on mechanical motion, such as a MEMS mechanical oscillator. The mechanical oscillator circuit 120 includes a gyroscope in some embodiments and includes a MEMS gyroscope in one embodiment. The mechanical oscillator circuit 120 is configured to generate a first periodic signal 123 that has a mechanical frequency fₘ and is provided to the calibration circuit 110. For example, the first periodic signal 123 may be a clock signal based on the natural frequency (i.e., resonant frequency) of the structure of the mechanical oscillator circuit 120.

The electrical oscillator circuit 130 may be any suitable type of oscillator based on oscillations of an electrical circuit. In various embodiments, the electrical oscillator circuit 130 is included in, includes, or is used by an accelerometer. For example, the MEMS device 100 may include an accelerometer that is configured to function using the electrical oscillator circuit 130 (even if the mechanical oscillator circuit 120 is unpowered, for example). The electrical oscillator circuit 130 is configured to generate a second periodic signal 133 that has an electrical frequency fₑ and is also provided to the calibration circuit 110. For example, the second periodic signal 133 may be a clock signal based on the natural frequency (i.e., resonant frequency) of a resonant circuit, such as a piezoelectric crystal, an RC circuit, LC circuit, RLC circuit, and others.

Although not necessarily required, the electrical frequency fₑ may be higher than the mechanical frequency fₘ in some embodiments (such as due to inherent properties of mechanical oscillators relative to electrical oscillators). In various embodiments, the electrical frequency fₑ is higher than the mechanical frequency fₘ by a factor rₒ (i.e., a nominal frequency ratio based on the design of the MEMS device 100), which may be a power of 2. In one embodiment, the electrical frequency fₑ is higher than the mechanical frequency fₘ by a factor of rₒ=2⁹=512, but of course any desired value is possible. For example, the electrical frequency fₑ may be about 10.24 MHz while the mechanical frequency fₘ may be about 20 kHz resulting in a nominal frequency ratio of rₒ=512. In other embodiments, the electrical frequency fₑ and the mechanical frequency fₘ may be different. As another example, the electrical frequency fₑ may be about 5.12 MHz while the mechanical frequency fₘ may be about 20 kHz resulting in a nominal frequency ratio of rₒ=256. Of course, other frequencies are possible.

The calibration circuit 110 includes a ratio circuit 140 that is configured to receive the first periodic signal 123 and the second periodic signal 133 (or a scaled version thereof). For example, the ratio circuit 140 may include a counter circuit 142 that is configured to generate a ratio signal 143 indicating a relationship (a ratio value rₘ) between the mechanical frequency fₘ and the electrical frequency fₑ. Specifically, the counter circuit 142 is coupled to both the mechanical oscillator circuit 120 and the electrical oscillator circuit 130, whether directly or through one or more intervening circuits.

The counter circuit 142 may be any suitable type of counter circuit, including synchronous and asynchronous, up or down, with appropriate size (e.g., selected to be able to count higher than the nominal frequency ratio rₒ). Further, any suitable digital components may be used to implement the counter circuit 142, such as various types of flip-flop or latch circuits, including data flip-flops (D flip-flops), set-reset flip-flops, (SR flip-flops), toggle flip-flips (T flip-flops), and JK flip-flops, among others.

An optional divider circuit 128 may be included between the counter circuit 142 and the first periodic signal 123 or the second periodic signal 133. In one embodiment, the optional divider circuit 128 is included between the first periodic signal 123 and the counter circuit 142, as shown. The optional divider circuit 128 is configured to divide the first periodic signal 123 by a divisor N to generate a divided periodic signal 127. For example, implementations of the MEMS device 100 that include the optional divider circuit 128 may have the advantage of increasing the accuracy of the ratio value I'm indicated by the ratio signal 143.

In one embodiment, the divided periodic signal 127 (or the first periodic signal 123 if the optional divider circuit 128 is not included) is coupled to an input of the counter circuit 142 (e.g., an enable input, for example) while the second periodic signal 133 is coupled to a clock input 148 of the counter circuit 142. In this specific example, the counter circuit 142 counts during each period of the divided periodic signal 127 (e.g., the count of the counter circuit 142 may be reset after each period of the divided periodic signal 127), providing a ratio of the electrical frequency fₑ to the mechanical frequency fₘ multiplied by the divisor N.

The ratio signal 143 is provided to an electrical correction calculator circuit 150 that is configured to output an electrical oscillator calibration signal 153 generated using the ratio signal 143 along with a predetermined mechanical oscillator calibration signal 155. The MEMS device 100 may include one or more internal registers 160 with the mechanical oscillator calibration signal 155 being stored in a mechanical trim register 161 as a mechanical calibration value GYₜᵣᵢₘ. In this context, the mechanical calibration value GYₜᵣᵢₘ may refer to a compensation value for the mechanical oscillator circuit 120 that is determined during a calibration process.

The mechanical calibration value GYₜᵣᵢₘ may be used to correct the actual mechanical frequency fₘ to be substantially equal to a nominal mechanical frequency fₘₒ (e.g., a trim value for adjusting the mechanical frequency fₘ of the mechanical oscillator circuit 120, which may be a gyroscope, to a target value). Such a calibration process is may be performed only once for a given MEMS device 100 as a factory calibration. For this reason, the mechanical calibration value GYₜᵣᵢₘ is a predetermined value indicated by the mechanical oscillator calibration signal 155 (at least from the perspective of the self-calibration methods described herein).

A similar predetermined value may be stored in an electrical trim register 162 of the internal registers 160 as an electrical calibration value XLₜᵣᵢₘ. For example, the electrical calibration value XLₜᵣᵢₘ may be used to correct the actual electrical frequency fₑ to be substantially equal to a nominal electrical frequency fₑₒ. That is, similar to the mechanical calibration value GYₜᵣᵢₘ, the electrical calibration value XLₜᵣᵢₘ may be an electrical trim value that is set during a factory calibration process and not updated or rarely updated during the lifetime of the device.

As already mentioned, updating calibration values such as GYₜᵣᵢₘ and XLₜᵣᵢₘ in response to drift, such as that caused by environmental effects, is impractical. For this reason the calibration circuit 110 of the MEMS device 100 is configured to generate the electrical oscillator calibration signal 153 using the electrical correction calculator circuit 150. The electrical oscillator calibration signal 153 may advantageously be used to correct the electrical frequency fₑ during the lifetime of the device, including during operation. In one embodiment, the electrical oscillator calibration signal 153 may be used to update the electrical correction value XLₜᵣᵢₘ stored in the electrical trim register 162. In other embodiments, the electrical oscillator calibration signal 153 may be stored in a different register to maintain the factory calibration value as a backup calibration value. Of course, other possibilities are also possible as may be apparent to those skilled in the art in view of the present disclosure.

The MEMS device 100 may be any type of MEMS device or devices that includes the mechanical oscillator circuit 120, the electrical oscillator circuit 130, and the calibration circuit 110. In various embodiments, the MEMS device 100 is a MEMS sensor device and is a MEMS inertial sensor device in some embodiments. In one embodiment, the MEMS device 100 comprises one or more ICs encapsulated in a single package, such as a land grid array (LGA) package.

The MEMS device 100 may be included as part of a system 115 that includes an application processor 180 and may include various other components. The MEMS device 100 may output a system clock 185 that may be used by the system 115. Of course, the system clock 185 may also be used internally as a time base for various components of the MEMS device 100. In various embodiments, the second periodic signal 133 having the electrical frequency fₑ is used as the basis for the system clock 185. In some embodiments, the first periodic signal 123 having the mechanical frequency fₘ may be used as the basis for the system clock 185. For example, since fₘ may be lower than the target frequency of the system clock 185, a PLL circuit 182 may be included and configured as a frequency multiplier circuit to increase the frequency of the first periodic signal 123 by a desired factor, such as the nominal frequency ratio rₒ, as shown.

In some implementations, the MEMS device 100 may be configured to choose whether to base the system clock 185 on the electrical oscillator circuit 130 (e.g., a local electronic oscillator) or the mechanical oscillator circuit 120 (e.g., a gyroscope). For example, a selector circuit 184 may be included to allow the MEMS device 100 to select which of the first periodic signal 123 or the second periodic signal 133 is used to generate the system clock 185.

The system clock 185 may be used by the system 115 (or the MEMS device 100 itself, depending on implementation) to control an output data rate (ODR). The ODR may be based on either the mechanical oscillator circuit 120 or the electrical oscillator circuit 130. In various embodiments, the ODR of the system 115 and/or the MEMS device 100 may be different from one or both of the electrical frequency fₑ and the mechanical frequency fₘ. For example, the maximum ODR may be on the order of tens of kilohertz, and is about 6.5 kHz in one embodiment.

The details of the operation of the electrical correction calculator circuit 150 may depend on the implementation of the surrounding components, such as the mechanical oscillator circuit 120 and the electrical oscillator circuit 130 as well as various parameters of the MEMS device 100. In one specific example, the electrical oscillator calibration signal 153 may be generated by the electrical correction calculator circuit 150 according to the following method.

The ratio signal 143 generated by the ratio circuit 140 may indicate the ratio between the electrical frequency fₑ and the mechanical frequency fₘ (the ratio value rₘ) in the form of Equation 1 (where the divisor N is equal to one when the optional divider circuit 128 is not included).

$${r}_{m} \text{?} \frac{N \cdot {f}_{e}}{{f}_{m}} \qquad Equation 1$$

The nominal (i.e., target) frequencies of the MEMS device 100 may be related by a scaling factor (e.g., the nominal frequency ratio rₒ). Additionally, the ODR may also be related to the fastest frequency of the MEMS device 100 (e.g., fₑ) by a scaling factor k. This gives the following two equations for the real ODR based on the electrical oscillator circuit 130 (labeled ODR_{XL} to reflect that an included accelerometer may be based on the electrical oscillator circuit 130 included as a local electronic oscillator of the MEMS device 100) and based on the mechanical oscillator circuit 120 (labeled ODR_{GY} to reflect that the mechanical oscillator circuit 120 may be or include a gyroscope).

$${ODR}_{XL} = \frac{{f}_{e}}{k} \qquad Equation 2$$

$${ODR}_{GY} = \frac{{r}_{0} \cdot {f}_{m}}{k} \qquad Equation 3$$

Solving Equation 3 for k and substituting into Equation 2 gives Equation 4 below. Rearranging Equation 1, it can be recognized that fₑ/fₘ=rₘ/N. Substituting this into Equation 4 results in Equation 5, which relates the real electrical and mechanical output data rates to the ratio value rₘ and the divisor N (when included).

$${ODR}_{GY} = {ODR}_{XL} \frac{{r}_{0} \cdot {f}_{m}}{{f}_{e}} \qquad Equation 4$$

$${ODR}_{GY} = {ODR}_{XL} \frac{{r}_{0} \cdot N}{{f}_{m}} \qquad Equation 5$$

While the real output data rates with their respective bases may be different (depending on the actual value of rₘ, which depends on device-to-device spread as well as environmental factors), the compensated (i.e., corrected) output data rates may be taken to be the same (as may be desirable to allow either to be used as a clock basis for the ODR, for example). This leads to Equation 6, showing the use of calibration values (e.g., trim values) to compensate the output data rates.

$${ODR}_{GY , comp} = {ODR}_{GY} \frac{k}{k + {GY}_{trim}} = {ODR}_{XL} \frac{k}{k + {XL}_{trim}} = {ODR}_{XL , comp} \qquad Equation 6$$

Substituting Equation 5 into Equation 6 yields Equation 7, which can be solved to obtain Equation 8: the electrical calibration value XLₜᵣᵢₘ (indicated the electrical oscillator calibration signal 153) in terms of rₘ (indicated by the ratio signal 143), rₒ, N, and GYₜᵣᵢₘ (indicated the mechanical oscillator calibration signal 155).

$$\frac{{r}_{0} \cdot N}{{r}_{m}} \cdot \frac{1}{k + {GY}_{trim}} = \frac{1}{k + {XL}_{trim}} \qquad Equation 7$$

$${XL}_{trim} = k ( \frac{{r}_{m}}{N \cdot {r}_{0}} - 1 ) + \frac{{r}_{m}}{{r}_{0} \cdot N} {GY}_{trim} = {e}_{1} + {e}_{2} \qquad Equation 8$$

As shown, Equation 8 can be thought of as having two correction terms, a first correction term e₁ and a second correction term e₂. Specifically, e₁ may be calculating by subtracting one from the ratio value rₘ divided by the nominal frequency ratio rₒ (scaled N, which may be one) and multiplying the result by k while e₂ may be calculated by multiplying the ratio value rₘ (again scaled by N) by the mechanical calibration value GYₜᵣᵢₘ and dividing by the nominal frequency ratio rₒ. Adding the first correction term e₁ to the second correction term e₂ provides the electrical calibration value XLₜᵣᵢₘ. It should be noted that in some embodiments N and rₒ are chosen to be powers of two (such as to avoid specific division hardware, for example).

The calibration circuit 110 may be triggered to generate the electrical oscillator calibration signal 153 in various ways. In one embodiment, the MEMS device 100 triggers the calibration circuit 110 using a calibration trigger signal 168 provided to a trigger input 116 of the calibration circuit 110 based on data stored in the internal registers 160. Additionally, since the mechanical oscillator circuit 120 may draw undesirably high currents during operation (e.g., relative to other components, such as the electrical oscillator circuit 130, for example), the mechanical oscillator circuit 120 may be unpowered when the calibration circuit 110 is triggered. An enable signal 167 may also be provided to an enable input 126 of the mechanical oscillator circuit 120 to power on the mechanical oscillator circuit 120 and generate the mechanical oscillator circuit 120. In one embodiment, the calibration circuit 110 is triggered at each startup of the mechanical oscillator circuit 120 (e.g., through a common signaling with the enable input 126 of the mechanical oscillator circuit 120 or through a different method including being triggered by the mechanical oscillator circuit 120).

The enable signal 167 is conceptually visualized as a separate signal than the calibration trigger signal 168. However, in some embodiments, the enable signal 167 and the calibration trigger signal 168 may be the same signal provided to both the trigger input 116 of the calibration circuit 110 and the mechanical oscillator circuit 120. Additionally, although it may be assumed that the electrical oscillator circuit 130 is powered and generating the second periodic signal 133 when the calibration circuit 110 is triggered, an enable signal (or the combined enable/trigger signal) may also be provided to the electrical oscillator circuit 130, if needed.

External control may also be desirable. For example, the application processor 180 may be configured to control the performance of the self-calibration method. In various embodiments, the controller is indirect, such as by using a data signal 183 provided to an interface 112 of the MEMS device 100. The data signal 183 may provide user data instructing the MEMS device 100 to trigger the calibration circuit 110. For example, stored values in the internal registers 160 may be adjusted according to the data signal 183 (to store user data) and the calibration circuit 110 (and the mechanical oscillator circuit 120) may be triggered/enabled. In some embodiments, user parameters for triggering the calibration circuit 110 to perform the self-calibration method may be stored in the internal registers 160, such as in one or more user registers 163.

Alternatively or additionally, the interface 112 may include direct control options for the calibration circuit 110, such as by allowing the application processor 180 to send an enable signal 187 and a calibration trigger signal 188 to the mechanical oscillator circuit 120 and the calibration circuit 110, respectively. It should be noted that although enable and trigger signals from different sources are conceptually drawn to be separate, when multiple signal options are included they can be connected at a single input (the trigger input 116 and/or the enable input 126) in some implementations. The interface 112 may be any suitable interface type, including an inter-integrated circuit (I²C) interface, an improved inter-integrated circuit (I3C) interface, a mobile industry processor interface (MIPI), or a serial peripheral interface (SPI), as examples.

Another option for triggering performance of the self-calibration routine by the calibration circuit 110 is to periodically perform the self-calibration. In various embodiments, the MEMS device 100 (or the system 115) includes a timer circuit 170 that is configured to control provide a calibration trigger signal 178 to the trigger input 116 of the calibration circuit 110 and a enable signal 177 to the enable input 126 of the mechanical oscillator circuit 120. In some embodiments, how often the self-calibration method is performed (i.e., the duration of time between each performance of the self-calibration) may be store in the internal registers 160, such as in a calibration interval register 164. This value may be static, may be altered only during factory calibration, or may be updated as desired by a user, such as using the data signal 183.

Since environmental factors may play a role in the desire to correct the actual frequency fₑ of the electrical oscillator circuit 130 (as well as signals based on this frequency, such as the system clock 185 or an ODR), an environmental sensor 171 may also be included in the system 115 (or in the MEMS device 100 itself) that is configured to trigger performance of the self-calibration routine. Specifically, an environmental signal 179 (which may be a group of signals from various sensors) may be provided to the interface 112 of the MEMS device 100.

The MEMS device 100 may include logic to identify environmental events indicating that the self-calibration methods should be triggered. For example, an environmental event circuit may be included that generates one or more trigger/enable signals to the calibration circuit 110 and the mechanical oscillator circuit 120 based on the environmental signal 179 (not shown here, but shown and discussed in specific examples of MEMS devices subsequently described).

The environmental sensor 171 may include one or more types of environmental sensor, and each type of sensor may include one sensor or an array of sensors. In one embodiment, the environmental sensor 171 includes a temperature sensor 172 that is configured to provide at least one temperature signal 173 to the MEMS device 100 as part of the environmental signal 179. In one embodiment, the environmental sensor 171 includes a humidity sensor 174 that is configured to provide at least one humidity signal 175 to the MEMS device 100 as part of the environmental signal 179. Of course, other types of sensors are also possible as may be apparent to those of skill in the art in view of the present disclosure.

The example registers discussed as being part of the internal registers 160 may each be one or more register and may be any suitable size. One or more of the internal registers 160 may also be user programmable (e.g., allowing direct or indirect user control over self-calibration). Additionally, the internal registers 160 may store any desirable data to effect the desired behavior of the calibration circuit 110 for a given application. For example, a history of calibration values may be stored for various reasons, including as backup values or to indicate possible anomalies in both the environment and the MEMS device 100 itself. Calibration values or parameters associated with certain environmental conditions may also be stored to allow accurate correction of the electrical oscillator circuit 130 for similar conditions without requiring the self-calibration method to be performed again.

FIG. 2 illustrates an example method for calibration of a MEMS device in accordance with embodiments of the invention. The method of FIG. 2 may be combined with other methods and performed using the systems and apparatuses as described herein. For example, the method of FIG. 2 may be combined with any of the embodiments of FIGS. 1 and 3-7. Although shown in a logical order, the arrangement and numbering of the steps of FIG. 2 are not intended to be limited. The method steps of FIG. 2 may be performed in any suitable order or concurrently with one another as may be apparent to a person of skill in the art.

Referring to FIG. 2, a method 200 begins with the generation of periodic signals based on a mechanical reference and an electrical reference. For example, the method includes both a mechanical frequency step 201 during which a first periodic signal with a mechanical frequency fₘ is generated using a mechanical oscillator circuit of a MEMS device and an electrical frequency step 202 during which a second periodic signal with an electrical frequency fₑ is generated using an electrical oscillator of the MEMS device. As already mentioned above, the mechanical oscillator circuit may be or include a gyroscope, such as a MEMS gyroscope while the electrical oscillator circuit may be or include an accelerometer, and may also be MEMS accelerometer.

A ratio signal indicating a relationship rₘ between the mechanical frequency fₘ and the electrical frequency fₑ is generated using a counter circuit (included in a specific implementation of a ratio circuit) of the MEMS device during a ratio step 204. For example, the ratio signal may be generated by the counter circuit by counting leading or trailing transitions of the second periodic signal for each period of the first periodic signal. In other embodiments, the ratio signal is generated by the counter circuit by counting leading or trailing transitions of a multiplied first periodic signal while a divided second periodic signal is high. Of course, other combinations are also possible as may be apparent to those skilled in the art in view of the present disclosure.

In some embodiments, the first or second periodic signal is divided during an optional divider step 203 to generate a divided periodic signal, which is then provided to the counter circuit (i.e., the frequency of the divided signal is less than the original undivided signal). In one embodiment, the first periodic signal (the mechanical signal with a lower frequency fₘ is divided by a divider circuit). In another embodiment, the second periodic signal (the electrical signal with frequency fₑ) is divided by the divider circuit.

The method 200 further includes an error correction step 205 during which an electrical oscillator calibration signal based on the ratio signal and a predetermined mechanical oscillator calibration signal is generated using an electrical correction calculator circuit of the MEMS device. For example, the electrical oscillator calibration signal may indicate an electrical correction value (e.g., an electrical trim value XLₜᵣᵢₘ), such as for an accelerometer included in the MEMS device that uses the electrical oscillator circuit (e.g., a local electronic oscillator).

The method 200 may be triggered in various ways, some examples of which are provided in the following. It should be noted that none of the following triggering techniques is mutually exclusive with the other techniques; any combination of the following techniques is possible. In one embodiment, the method 200 is triggered according to a predetermined or programmable time period (periodic trigger 206). For example, a timing circuit included in the MEMS device or in a system including the MEMS device may be used to trigger the method 200 according to a time interval that may be stored in register storage of the MEMS device. The interval between trigger events (the trigger period) may be predetermined and may be programmable (e.g., by a user or manufacturer).

In another embodiment, the method 200 is triggered according to a user preference using (user trigger 207). This be implemented in a variety of ways, and include direct and indirect user triggering of the method 200. In still another embodiment, the method 200 is triggered according to an environmental event, which may be a change some measurable quantity, such as a change in temperature or humidity (environmental trigger 208). In still yet another embodiment, the method 200 is triggered at each startup of the mechanical oscillator circuit (startup trigger 209).

The required execution time for the method 200 may have the advantage of being lower than conventional calibration methods and/or other methods of correcting the frequency generated by an electrical oscillator. In various embodiments, the execution time of the method 200 is on the order of a few hundreds of milliseconds down to less than about 100 ms in some embodiments. In one embodiment, the execution time of the method 200 is less than about 250 ms. The lower boundary for the execution time may depend on various factors and may depend on the details of a specific application. In some implementations, the lower boundary of the execution time depends on the startup time of the mechanical oscillator circuit (e.g., a gyroscope). In one embodiment, the execution time of the method 200 is between about 50 ms and about 100 ms.

FIG. 3 illustrates an example MEMS device that is configured to be triggered to perform a self-calibration method by an application processor according to a user preference in accordance to embodiments of the invention. The MEMS device of FIG. 3 may be a specific implementation of other MEMS devices described herein such as the MEMS device of FIG. 1, for example. Similarly labeled elements may be as previously described.

Referring to FIG. 3, a MEMS device 300 includes a calibration circuit 310 that is configured to receive a first periodic signal 323 with a mechanical frequency fₘ from a mechanical oscillator circuit 320 and receive a second periodic signal 333 with electrical frequency fₑ from an electrical oscillator circuit 330. The MEMS device 300 may be included as part of a system 315 that includes an application processor 380 and may include various other components. The MEMS device 300 may include an interface 312 through which the application processor 380 may communicate with the MEMS device 300. The MEMS device 300 is configured to generate a system clock 385 that is based on the electrical oscillator circuit 330 (e.g., on a local electronic oscillator), which may be used by the MEMS device 300 or by the system 315, such as to define an output data rate, for example.

It should be noted that here and in the following a convention has been adopted for brevity and clarity wherein elements adhering to the pattern [x10] where ‘x’ is the figure number may be related implementations of a calibration circuit in various embodiments. For example, the calibration circuit 310 may be similar to the calibration circuit 110 except as otherwise stated. An analogous convention has also been adopted for other elements as made clear by the use of similar terms in conjunction with the aforementioned numbering system.

The calibration circuit 310 is configured to generate an electrical oscillator calibration signal 353 (e.g., indicating a trim value for the electrical oscillator circuit 330 XLₜᵣᵢₘ) based on a relationship between the mechanical frequency fₘ and the electrical frequency fₑ and on a predetermined mechanical correction value GYₜᵣᵢₘ. The mechanical correction value GYₜᵣᵢₘ may be stored in one or more internal registers 360. Similarly, other values may also be stored, such as an electrical correction value XLₜᵣᵢₘ (which may be updated by the electrical oscillator calibration signal 353).

In this specific example, the internal registers 360 of the MEMS device 300 includes one or more user registers 363, which may be used to influence the self-calibration behavior of the MEMS device 300. For example, the application processor 380 may be configured to directly or indirectly trigger the MEMS device 300 to perform the self-calibration method according to a user preference.

In one embodiment, the application processor 380 uses a data signal 383 to instruct appropriate registers of the internal registers 360 to be updated (such as the user registers). The internal registers 360 then trigger performance of the self-calibration routine, such as using a enable signal 367 to ensure that the mechanical oscillator circuit 320 is powered on and a calibration trigger signal 368 cause the calibration circuit 310 to perform the self-calibration. In other embodiments, the application processor 380 triggers the self-calibration routine directly, such as using an enable signal 387 and a calibration trigger signal 388. In some embodiments, the MEMS device 300 is configured to all both direct and indirect triggering by an external component, such as the application processor 380.

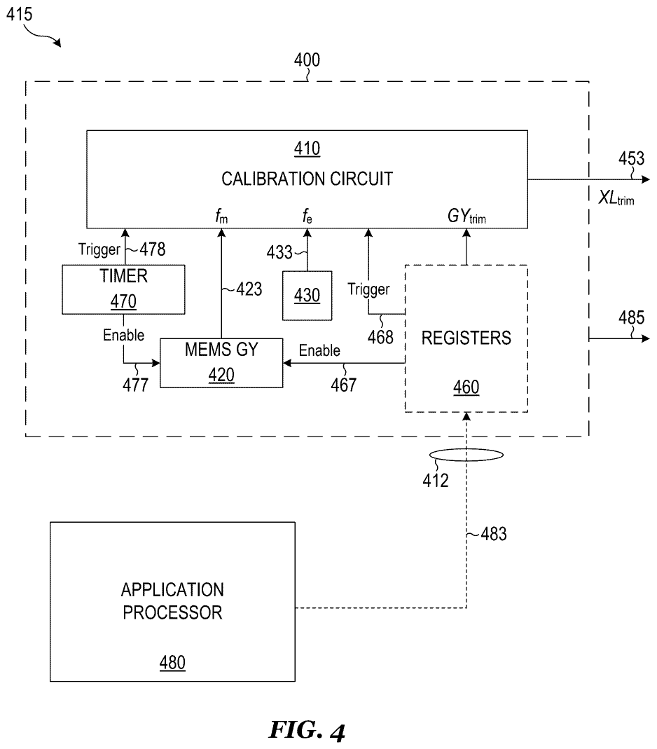

FIG. 4 illustrates an example MEMS device that includes a timing circuit configured to periodically trigger performance of a self-calibration method in accordance with embodiments of the invention. The MEMS device of FIG. 4 may be a specific implementation of other MEMS devices described herein such as the MEMS device of FIG. 1, for example. Similarly labeled elements may be as previously described.

Referring to FIG. 4, a MEMS device 400 includes a calibration circuit 410 that is configured to receive a first periodic signal 423 with a mechanical frequency fₘ from a mechanical oscillator circuit 420 and receive a second periodic signal 433 with electrical frequency fₑ from an electrical oscillator circuit 430. The MEMS device 400 may be included as part of a system 415 that includes an application processor 480 and may include various other components. The MEMS device 400 may include an interface 412 through which the application processor 480 may communicate with the MEMS device 400, such as using a data signal 483. The MEMS device 400 is configured to generate a system clock 485 that is based on the electrical oscillator circuit 430 (e.g., on a local electronic oscillator), which may be used by the MEMS device 400 or by the system 415, such as to define an output data rate, for example.

The calibration circuit 410 is configured to generate an electrical oscillator calibration signal 453 (e.g., indicating a trim value for the electrical oscillator circuit 430 XLₜᵣᵢₘ) based on a relationship between the mechanical frequency fₘ and the electrical frequency fₑ and on a predetermined mechanical correction value GYₜᵣᵢₘ. The mechanical correction value GYₜᵣᵢₘ may be stored in one or more internal registers 460. Similarly, other values may also be stored, such as an electrical correction value XLₜᵣᵢₘ (which may be updated by the electrical oscillator calibration signal 453).

In this specific example, a timer circuit 470 is included in the MEMS device 400 and configured to trigger performance of a self-calibration routine of the MEMS device 400 using an enable signal 477 and a calibration trigger signal 478 periodically according to a predetermined or programmable time period. Specifically, the MEMS device 400 uses the timer circuit 470 to perform a self-calibration of the electrical oscillator circuit 430 based on the mechanical oscillator circuit 420 and the mechanical correction value GYₜᵣᵢₘ after a desired amount of time has passed. The interval between self-calibrations may be static or may be programmable.

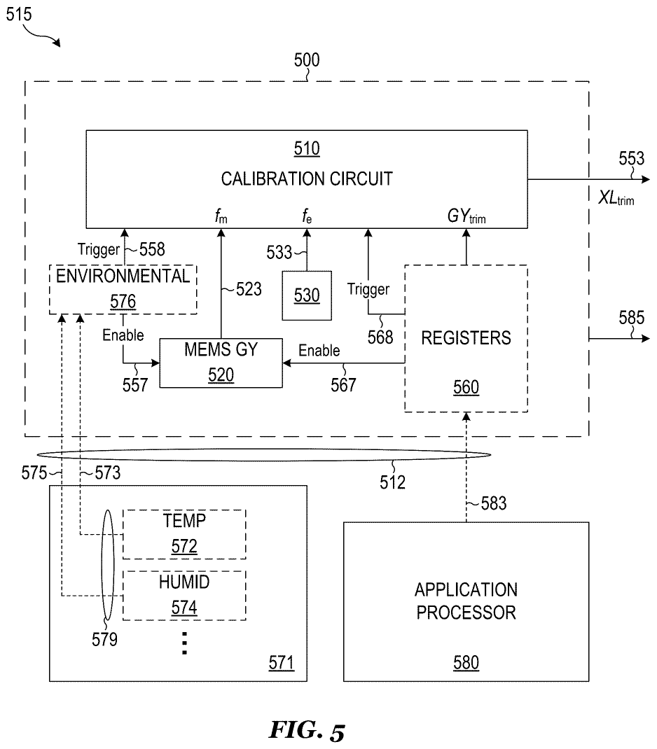

FIG. 5 illustrates an example MEMS device that includes an environmental circuit configured to trigger performance of a self-calibration method based on an environmental event detected using an environmental signal from an environmental sensor in accordance with embodiments of the invention The MEMS device of FIG. 5 may be a specific implementation of other MEMS devices described herein such as the MEMS device of FIG. 1, for example. Similarly labeled elements may be as previously described.

Referring to FIG. 5, a MEMS device 500 includes a calibration circuit 510 that is configured to receive a first periodic signal 523 with a mechanical frequency fₘ from a mechanical oscillator circuit 520 and receive a second periodic signal 533 with electrical frequency fₑ from an electrical oscillator circuit 530. The MEMS device 500 may be included as part of a system 515 that includes an application processor 580 and may include various other components. The MEMS device 500 may include an interface 512 through which the application processor 580 may communicate with the MEMS device 500, such as using a data signal 583. The MEMS device 500 is configured to generate a system clock 585 that is based on the electrical oscillator circuit 530 (e.g., on a local electronic oscillator), which may be used by the MEMS device 500 or by the system 515, such as to define an output data rate, for example.

The calibration circuit 510 is configured to generate an electrical oscillator calibration signal 553 (e.g., indicating a trim value for the electrical oscillator circuit 530 XLₜᵣᵢₘ) based on a relationship between the mechanical frequency fₘ and the electrical frequency fₑ and on a predetermined mechanical correction value GYₜᵣᵢₘ. The mechanical correction value GYₜᵣᵢₘ may be stored in one or more internal registers 560. Similarly, other values may also be stored, such as an electrical correction value XLₜᵣᵢₘ (which may be updated by the electrical oscillator calibration signal 553).

In this specific example, the system 515 (or the MEMS device 500 itself) includes an environmental sensor 571, which may be a single sensor or multiple sensors, and may include sensors of different types. The environmental sensor 571 is configured to send an environmental signal 579 to an environmental event circuit 576 of the MEMS device 500. The environmental signal 579 may be a single signal or multiple signals that may be sent to the environmental event circuit 576 using a single signal line or multiple signal lines. In some embodiments, the environmental sensor 571 may communicate using the same signal line as the data signal 583.

The environmental event circuit 576 is configured to trigger the MEMS device 500 to perform a self-calibration routine according to an environmental event determined based on the environmental signal 579 using an enable signal 557 and a calibration trigger signal 558. In one embodiment, the environmental sensor 571 includes a temperature sensor 572 that is configured to send a temperature signal 573 to the environmental event circuit 576. The environmental event circuit 576 is configured to pulse the enable signal 557 and the calibration trigger signal 558 when a temperature event is detected, such as a rapid change in temperature or the temperature exceeding a predefined threshold or thresholds.

In another embodiment, the environmental sensor 571 includes a humidity sensor 574 that is configured to send a humidity signal 575 to the environmental event circuit 576. As before, the environmental event circuit 576 is configured to pulse the enable signal 557 and the calibration trigger signal 558 when a humidity event is detected, such as based on the rate of change of the humidity or one or more humidity thresholds. Of course, the environmental sensor 571 may include both a temperature sensor 572 and a humidity sensor 574 in some embodiments, and other environmental sensors may also be included.

FIG. 6 illustrates a specific example of an environmental circuit that is configured to receive a temperature signal from a temperature sensor and trigger performance of a self-calibration method based on a temperature event detected using the temperature signal in accordance with embodiments of the invention. The environmental circuit may be included in any of the MEMS devices described herein, such as the MEMS device of FIG. 1, for example. Similarly labeled elements may be as previously described.

Referring to FIG. 6, a MEMS device 600 includes an environmental event circuit 676 that is configured to detect an environmental event based on a temperature signal 673 (e.g., received from one or more temperature sensors). Although the environmental event circuit 676 is specifically configured to generate a temperature-base event, the same concept may be applied to other types of environmental sensors, such as a humidity sensor, and others.

The environmental event circuit 676 includes a temperature processing circuit 631 that is configured to receive and process the temperature signal 673 to distribute the temperature information to other components of the environmental event circuit 676. In this specific example, the temperature signal 673 is distributed to two paths, each configured to detect a different type of temperature event. However, other implementations may only include one of the paths or may include different paths or combinations of paths.

The upper event path of the environmental event circuit 676 includes a difference circuit 637 that is configured to output the difference between the incoming temperature information and past temperature information. In this way the difference circuit 637 is configured to provide information about the rate of change of the temperature in the environment of the MEMS device 600. In one embodiment, the difference circuit 637 is configured to use the incoming temperature information as a current temperature reading and subtract the previous temperature reading (a first order approximation of the derivative of the temperature with respect to time, for example). In some embodiments, the difference circuit 637 is replaced by other circuits configured to provide information about the rate of change of the temperature.

A rate threshold circuit 635 is configured to compare the output of the difference circuit 637 to a threshold and output the result to an OR gate 638. The behavior of the rate threshold circuit 635 may be based on the details of a given application. For example, the reference threshold circuit 636 may output a high signal when the absolute value of the rate of temperature change exceeds a threshold, or output a high signal when the rate of change exceeds a positive threshold or when the rate of change falls below a negative threshold.

The OR gate is a digital logic component that is included to allow more than one temperature event to cause an output of the environmental event circuit 676. The OR gate 638 outputs a high signal if either input is high. The output of the OR gate 638 may be configured to be used as an enable signal 657 and a calibration trigger signal 658, as shown. Alternatively, the detection of a temperature event may be sent to other logic circuits as part of a more complicated decision tree for when to trigger self-calibration.

The lower event path of the environmental event circuit 676 includes a subtractor circuit 632 that also receives the temperature information from the temperature processing circuit 631. Additionally, the subtractor circuit 632 receives a reference temperature T_{ref} from a reference temperature register 639. The subtractor circuit 632 subtracts the reference temperature T_{ref} from the incoming temperature information and provides the output to a reference threshold circuit 636, which operates similarly to the rate threshold circuit 635 described above. In contrast to the upper event path, the lower event path may provide information about degree of deviation of the current temperature from the reference temperature T_{ref} using the reference threshold circuit 636. As before, the output of the reference threshold circuit 636 is received by the OR gate 638 and provides another possible way to trigger self-calibration.

In some embodiments, the reference temperature register 639 may be updated. For example, the temperature processing circuit 631 may set and/or update the reference temperature register 639 using a reference set signal 629 based on desired criteria. Similarly, a reference update signal 634 may be provided as a feedback signal from the output of the reference threshold circuit 636 and may also be used to update the reference temperature register 639 based on desired criteria.

FIG. 7 illustrates a specific example of a MEMS device where the electrical oscillator circuit is coupled to an optional divider circuit and the counter circuit receives an output signal of a phase-locked loop coupled to the mechanical oscillator circuit at a clock input in accordance with embodiments of the invention. The MEMS device of FIG. 7 is an alternative implementation of the MEMS device of FIG. 1 in a symmetric configuration. Similarly labeled elements may be as previously described.

Referring to FIG. 7, a simplified view of a MEMS device 700 includes a calibration circuit 710 that is operatively coupled to both a mechanical oscillator circuit 720 and an electrical oscillator circuit 730. The mechanical oscillator circuit 720 is configured to generate a first periodic signal that has a mechanical frequency fₘ and is provided to a clock input of a counter circuit 742 of the calibration circuit 710 (which may be modified by an intervening PLL circuit 782, as shown). The electrical oscillator circuit 730 is configured to generate a second periodic signal that has an electrical frequency fₑ and is also provided to the calibration circuit 710, such as to an optional divider circuit 728. Of course, while the MEMS device 700 is illustrated here in a simplified view, the MEMS device 700 may include any of the details shown and described in more detail herein, such as in the description of the MEMS device 100 of FIG. 1, for example.

The calibration circuit 710 includes a ratio circuit 740 that is configured to receive the first periodic signal and the second periodic signal (or a scaled version thereof). For example, the ratio circuit 740 may include the counter circuit 742, which is configured to generate a ratio signal 743 indicating a relationship (a ratio value rₘᵢ, which may be considered an inverse ratio compared to the rₘ previously described) between the mechanical frequency fₘ and the electrical frequency fₑ.

The ratio signal 743 is provided to an electrical correction calculator circuit 750 that is configured to output an electrical oscillator calibration signal 753 generated using the ratio signal 743 along with a predetermined mechanical oscillator calibration signal that may be received from a mechanical trim register 761 storing a mechanical calibration value GYₜᵣᵢₘ. The mechanical trim register 761 may be included in one or more internal registers 760, which may also include other registers, such as an electrical trim register 762, for example. As before, the MEMS device 700 may be configured to choose whether to base a system clock 785 on the electrical oscillator circuit 730 (e.g., a local electronic oscillator) or the mechanical oscillator circuit 720 (e.g., a gyroscope). For example, a selector circuit 784 may be included to allow the MEMS device 700 to select which of the first periodic signal or the second periodic signal is used to generate the system clock 785.

The inversion of the outputs of the mechanical oscillator circuit 720 and the electrical oscillator circuit 730 relative to the counter circuit 742 of the ratio circuit 740 may affect the meaning of the ratio signal 743 output to the electrical correction calculator circuit 750 relative to the configuration of FIG. 1. For example, the ratio signal 743 output by the ratio circuit 740 may now indicate a ratio rₘᵢ that can be represented as Equation 9.

$${r}_{mi} \text{?} \frac{N \cdot {r}_{0} \cdot {f}_{m}}{{f}_{e}} \qquad Equation 9$$

A similar approach as previously described then leads to Equation 10, which shows how the electrical calibration value XLₜᵣᵢₘ (indicated by the electrical oscillator calibration signal 753) relates to the ratio rₘᵢ. Again, Equation 10 can be thought of as having two error terms e₃ and e₄ which are analogous to, but differ from, the error terms discussed in the foregoing.

$${XL}_{trim} = k ( \frac{N}{{r}_{mi}} - 1 ) + \frac{N}{{r}_{mi}} {GY}_{trim} = {e}_{3} + {e}_{4} \qquad Equation 10$$

Example embodiments of the invention are summarized here. Other embodiments can also be understood from the entirety of the specification as well as the claims filed herein.

Example 1. A method for calibration of a microelectromechanical system (MEMS) device, the method including: generating a first periodic signal with a mechanical frequency using a mechanical oscillator circuit of the MEMS device; generating a second periodic signal with an electrical frequency using an electrical oscillator circuit of the MEMS device; generating a ratio signal indicating a relationship between the mechanical frequency and the electrical frequency using a counter circuit of the MEMS device; and generating an electrical oscillator calibration signal based on the ratio signal and a predetermined mechanical oscillator calibration signal using an electrical correction calculator circuit of the MEMS device.

Example 2. The method of example 1, further including: dividing the first periodic signal or the second periodic signal using a divider circuit to generate a divided periodic signal; and outputting the divided periodic signal to the counter circuit, the ratio signal being generated according to the divided periodic signal and the second periodic signal or the first periodic signal.

Example 3. The method of example 2, where the divided periodic signal is generated by dividing the first periodic signal using the divider circuit, and where the ratio signal is generated according to the divided periodic signal and the second periodic signal.

Example 4. The method of example 2, where the divided periodic signal is generated by dividing the second periodic signal using the divider circuit, and where the ratio signal is generated according to the divided periodic signal and the first periodic signal.

Example 5. The method of one of examples 1 to 4, where the ratio signal is generated by the counter circuit by counting leading or trailing transitions of the second periodic signal during each period of the first periodic signal.

Example 6. The method of one of examples 1 to 4, where the ratio signal is generated by the counter circuit by counting leading or trailing transitions of a multiplied first periodic signal during each period of a divided second periodic signal.

Example 7. The method of one of examples 1 to 6, where generating the electrical oscillator calibration signal includes: calculating a first correction term by subtracting one from a ratio value indicated by the ratio signal and dividing the ratio value by a nominal frequency ratio and multiplying the result by a scaling factor, the nominal frequency ratio being the ratio between a nominal mechanical frequency and a nominal electronic frequency of the MEMS device; calculating a second correction term by multiplying the ratio value by a mechanical calibration value indicated by the predetermined mechanical oscillator calibration signal divided by the nominal frequency ratio; and adding the first correction term to the second correction term.

Example 8. The method of one of examples 1 to 7, where: the mechanical oscillator circuit includes a gyroscope; and the electrical oscillator circuit includes an accelerometer.

Example 9. The method of one of examples 1 to 8, where an execution time for performing the method is less than about 250 ms.

Example 10. The method of example 9, where the execution time is between about 50 ms and about 100 ms.

Example 11. The method of one of examples 1 to 10, further including: triggering performance of the method periodically according to a predetermined or programmable period.

Example 12. The method of one of examples 1 to 11, further including: triggering performance of the method at each startup of the mechanical oscillator circuit.

Example 13. The method of one of examples 1 to 12, further including: triggering performance of the method according to a user preference.

Example 14. The method of one of examples 1 to 13, further including: triggering performance of the method according to an environmental event.

Example 15. The method of example 14, where the environmental event includes a temperature event.

Example 16. The method of one of examples 14 and 15, where the environmental event includes a humidity event.

Example 17. A microelectromechanical system (MEMS) device including: a mechanical oscillator circuit configured to generate a first periodic signal with a mechanical frequency; an electrical oscillator circuit configured to generate a second periodic signal with an electrical frequency; a counter circuit coupled to the mechanical oscillator circuit and the electrical oscillator circuit, the counter circuit being configured to generate a ratio signal indicating a relationship between the mechanical frequency and the electrical frequency; and an electrical correction calculator circuit coupled to the counter circuit and configured to output an electrical oscillator calibration signal generated using the ratio signal and a predetermined mechanical oscillator calibration signal.

Example 18. The MEMS device of example 17, further including: a divider circuit coupled to the counter circuit and configured to divide the first periodic signal or the second periodic signal to generate a divided periodic signal, and output the divided periodic signal to the counter circuit.

Example 19. The MEMS device of one of examples 17 and 18, further including: a timer circuit configured to cause the MEMS device to periodically enable the mechanical oscillator circuit and output the electrical oscillator calibration signal according to a predetermined or programmable period.

Example 20. The MEMS device of one of examples 17 to 19, further including: one or more registers configured to control generation and output of the electrical oscillator calibration signal.

Example 21. The MEMS device of example 20, where the one or more registers are user programmable.

Example 22. The MEMS device of one of examples 17 to 21, where the MEMS device is configured to generate and output the electrical oscillator calibration signal at each startup of the mechanical oscillator circuit.

Example 23. The MEMS device of one of examples 17 to 22, where: the mechanical oscillator circuit includes a gyroscope; and the electrical oscillator circuit includes an accelerometer.

Example 24. A system including: a MEMS device including a mechanical oscillator circuit, an electrical oscillator circuit, a counter circuit coupled to the mechanical oscillator circuit and the electrical oscillator circuit, and an electrical correction calculator circuit coupled to the counter circuit, the MEMS device being configured to perform a method for calibration of the MEMS device, the method including: generating a first periodic signal with a mechanical frequency using the mechanical oscillator circuit, generating a second periodic signal with an electrical frequency using the electrical oscillator circuit, generating a ratio signal indicating a relationship between the mechanical frequency and the electrical frequency using the counter circuit, generating an electrical oscillator calibration signal based on the ratio signal and a predetermined mechanical oscillator calibration signal using the electrical correction calculator circuit, and correcting the second periodic signal using the electrical oscillator calibration signal to generate a corrected periodic signal; and an application processor configured to use the corrected periodic signal as a system clock.

Example 25. The system of example 24, where the MEMS device further includes: a divider circuit coupled between the mechanical oscillator circuit and the counter circuit and configured to divide the first periodic signal to generate a divided periodic signal output to the counter circuit.

Example 26. The system of one of examples 24 and 25, where the MEMS device further includes: a timer circuit configured to trigger the MEMS device to perform the method periodically according to a predetermined or programmable period.

Example 27. The system of one of examples 24 to 26, where the application processor is configured to trigger the MEMS device to perform the method.

Example 28. The system of example 27, where performance of the method is triggered by the application processor according to user data.

Example 29. The system of example 28, where the MEMS device further includes: one or more registers configured to store the user data.

Example 30. The system of one of examples 24 to 29, further including: an environmental sensor included in or coupled to the MEMS device, the MEMS device being further configured to perform the method according to an environmental event generated from an environmental signal of the environmental sensor.

Example 31. The system of example 30, where the environmental sensor includes a temperature sensor, the environmental event being a temperature event and the environmental signal including a temperature signal from the temperature sensor.

Example 32. The system of one of examples 30 and 31, where the environmental sensor includes a humidity sensor, the environmental event being a humidity event and the environmental signal including a humidity signal from the humidity sensor.

Example 33. The system of the one of examples 24 to 32, where: the mechanical oscillator circuit includes a gyroscope of the MEMS device; and the electrical oscillator circuit includes an accelerometer of the MEMS device.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for calibration of a microelectromechanical system (MEMS) device, the method comprising:
generating a first periodic signal with a mechanical frequency using a mechanical oscillator circuit of the MEMS device;
generating a second periodic signal with an electrical frequency using an electrical oscillator circuit of the MEMS device;
generating a ratio signal indicating a relationship between the mechanical frequency and the electrical frequency using a counter circuit of the MEMS device; and
generating an electrical oscillator calibration signal based on the ratio signal and a predetermined mechanical oscillator calibration signal using an electrical correction calculator circuit of the MEMS device.

2. The method of claim 1, further comprising:
dividing the first periodic signal using a divider circuit to generate a divided periodic signal; and
outputting the divided periodic signal to the counter circuit, the ratio signal being generated according to the divided periodic signal and the second periodic signal.

3. The method of claim 1, wherein the ratio signal is generated by the counter circuit by counting leading or trailing transitions of the second periodic signal during each period of the first periodic signal.

4. The method of claim 1, wherein the ratio signal is generated by the counter circuit by counting leading or trailing transitions of a multiplied first periodic signal during each period of a divided second periodic signal.

5. The method of claim 1, wherein generating the electrical oscillator calibration signal comprises:
calculating a first correction term by subtracting one from a ratio value indicated by the ratio signal and dividing the ratio value by a nominal frequency ratio and multiplying the result by a scaling factor, the nominal frequency ratio being the ratio between a nominal mechanical frequency and a nominal electronic frequency of the MEMS device;
calculating a second correction term by multiplying the ratio value by a mechanical calibration value indicated by the predetermined mechanical oscillator calibration signal divided by the nominal frequency ratio; and
adding the first correction term to the second correction term.

6. The method of claim 1, wherein:
the mechanical oscillator circuit comprises a gyroscope; and
the electrical oscillator circuit comprises an accelerometer.

7. The method of claim 1, wherein an execution time for performing the method is less than about 250 ms.

8. The method of claim 1, further comprising:
triggering performance of the method periodically according to a predetermined or programmable period.

9. The method of claim 1, further comprising:
triggering performance of the method according to a temperature event or a humidity event.

10. A microelectromechanical system (MEMS) device comprising:
a mechanical oscillator circuit configured to generate a first periodic signal with a mechanical frequency;
an electrical oscillator circuit configured to generate a second periodic signal with an electrical frequency;
a counter circuit coupled to the mechanical oscillator circuit and the electrical oscillator circuit, the counter circuit being configured to generate a ratio signal indicating a relationship between the mechanical frequency and the electrical frequency; and
an electrical correction calculator circuit coupled to the counter circuit and configured to output an electrical oscillator calibration signal generated using the ratio signal and a predetermined mechanical oscillator calibration signal.

11. The MEMS device of claim 10, further comprising:
a divider circuit coupled to the counter circuit and configured to divide the first periodic signal or the second periodic signal to generate a divided periodic signal, and
output the divided periodic signal to the counter circuit.

12. The MEMS device of claim 10, further comprising:
a timer circuit configured to cause the MEMS device to periodically enable the mechanical oscillator circuit and output the electrical oscillator calibration signal according to a predetermined or programmable period.

13. The MEMS device of claim 10, wherein:
the mechanical oscillator circuit comprises a gyroscope; and
the electrical oscillator circuit comprises an accelerometer.

14. A system comprising:
a microelectromechanical system (MEMS) device comprising a mechanical oscillator circuit, an electrical oscillator circuit, a counter circuit coupled to the mechanical oscillator circuit and the electrical oscillator circuit, and an electrical correction calculator circuit coupled to the counter circuit, the MEMS device being configured to perform a method for calibration of the MEMS device, the method comprising
generating a first periodic signal with a mechanical frequency using the mechanical oscillator circuit,
generating a second periodic signal with an electrical frequency using the electrical oscillator circuit,
generating a ratio signal indicating a relationship between the mechanical frequency and the electrical frequency using the counter circuit,
generating an electrical oscillator calibration signal based on the ratio signal and a predetermined mechanical oscillator calibration signal using the electrical correction calculator circuit, and
correcting the second periodic signal using the electrical oscillator calibration signal to generate a corrected periodic signal; and
an application processor configured to use the corrected periodic signal as a system clock.

15. The system of claim 14, wherein the MEMS device further comprises:
a divider circuit coupled between the mechanical oscillator circuit and the counter circuit and configured to divide the first periodic signal to generate a divided periodic signal output to the counter circuit.

16. The system of claim 14, wherein the MEMS device further comprises:
a timer circuit configured to trigger the MEMS device to perform the method periodically according to a predetermined or programmable period.

17. The system of claim 14, wherein the MEMS device further comprises:
one or more registers configured to store user data, the application processor being configured to trigger the MEMS device to perform the method according to the user data.

18. The system of claim 14, further comprising:
a temperature sensor included in or coupled to the MEMS device, the MEMS device being further configured to perform the method according to a temperature event generated from a temperature signal of the temperature sensor.

19. The system of claim 14, further comprising:
a humidity sensor included in or coupled to the MEMS device, the MEMS device being further configured to perform the method according to a humidity event generated from a humidity signal of the humidity sensor.

20. The system of the claim 14, wherein:
the mechanical oscillator circuit comprises a gyroscope of the MEMS device; and
the electrical oscillator circuit comprises an accelerometer of the MEMS device.
